(19) United States
(12) Patent Application Publication
(10) Pub. No.: US 2014/0362771 A1
(43) Pub. Date: Dec. 11, 2014

(54) APPARATUS AND METHOD FOR CONTROLLING LOCAL AREA COMMUNICATION CONNECTION BY MEANS OF WIRELESS TERMINAL DEVICE

(71) Applicant: Samsung Electronics Co., Ltd., Suwon-si, Gyeonggi-do (KR)

(72) Inventors: Se-Hoon Kim, Seoul (KR); Do-Young Kim, Hwaseong-si (KR); Eun-Hui Bae, Seoul (KR); Nae-Hyun Lim, Seoul (KR); Hyoung-Kyu Lim, Seoul (KR); Chi-Hong Cho, Suwon-si (KR)

(21) Appl. No.: 14/369,495

(22) PCT Filed: Dec. 27, 2012
(86) PCT No.: PCT/KR2012/011603

§ 371 Date: Jun. 27, 2014

(30) Foreign Application Priority Data
Dec. 27, 2011 (KR) 10-2011-0143680

(51) Int. Cl. H04W 76/02; H04W 76/06; H04W 48/16

(52) U.S. Cl. CPC H04W 76/021; H04W 48/16; H04W 76/064
USPC 370/328

(57) ABSTRACT

An apparatus and a method for controlling a connection to a local area wireless communication network on the basis of a communication environment by means of a wireless terminal device are provided. To this end, the wireless terminal device collects information regarding a neighboring base station that constitutes a public communication network by means of a cell search, and determines whether it is possible to connect to a local area communication network on the basis of the collected information regarding the neighboring base station. If it is determined to be possible to connect to a local area communication network, the wireless terminal device makes an attempt to connect to a pre-registered wireless connection device on the basis of the collected information regarding the neighboring base station.

### CROSS-REFERENCE TO RELATED APPLICATION(S)

This application is a U.S. National Stage application under 35 U.S.C. §371 of an International application filed on Dec. 27, 2012 and assigned application number PCT/KR2012/011603, which claimed the benefit of a Korean patent application filed on Dec. 27, 2011 in the Korean Intellectual Property Office and assigned Serial number 10-2011-0143680, the entire disclosure of which is hereby incorporated by reference.

### TECHNICAL FIELD

The present disclosure relates to an apparatus and a method for controlling a short-range communication connection in a user equipment. More particularly, the present disclosure relates to an apparatus and a method for controlling a connection to a wireless local area network based on a communication environment in a user equipment.

### BACKGROUND

In the related art, a Local Area Network (LAN) denotes a network in which communication between terminals occurs through a communication line at a distance less than or equal to 300 m. Here, LANs are divided into a wired LAN and a wireless LAN according to the type of communication line which connects terminals.

The wired LAN is a communication network which connects communication terminals by wire within a particular area, such as a building, a campus, and the like. A representative wired LAN is an Ethernet. In contrast, the wireless LAN is a communication network which connects communication terminals (hereinafter referred to as “User Equipments (UEs)”) located within a particular area via an Access Point (AP) which covers the particular area, such as a building, a campus, a specialty coffee shop, and the like. A representative wireless LAN is Wi-Fi. Wi-Fi is a logo that Wireless Ethernet Compatibility Alliance (WECA) provides as IEEE 802.11a/IEEE 802.11b which are standards for the wireless LAN. However, Wi-Fi is currently used as a meaning representative of the wireless LAN.

Typically, a wireless LAN is used by a small group at home or in a company, but a region in which the wireless LAN is used is being expanded due to the activation of a smart phone market.

Typically, separate charging is performed in the case of connecting to a Public Mobile Network (PMN), such as a Third Generation (3G) network, a Fourth Generation (4G) network, and the like, but is not performed in the case of connecting to the wireless LAN. Accordingly, most users, having UEs capable of selectively connecting to the wireless LAN and the PMN, such as the 3G network, the 4G network, and the like, prefer to use the wireless LAN. However, although the region in which the wireless LAN is used is expanded, the wireless LAN is more limited in a service area than the PMN.

Due to the above-described reasons, in order to use the wireless LAN in preference to the PMN, a user has to be able to always activate a function of using the wireless LAN (hereinafter referred to as a “wireless LAN module”) in the UE, or has to be able to recognize whether the user can use the wireless LAN at a current location.

However, when the wireless LAN module is always activated regardless of the availability of the wireless LAN, power may be consumed while the UE unnecessarily discovers a wireless LAN (i.e., a neighboring AP), to which the UE can connect, and connects to the neighboring AP based on a result of the discovery.

Accordingly, the user typically deactivates the wireless LAN module in order to reduce the power consumption of the UE. As the need arises, the user activates the wireless LAN module of the UE, and uses a communication service through the wireless LAN.

Hereinafter, for convenience of description, it should be noted that the term “UE” is used to indicate a wireless terminal device that selectively supports a service through the wireless LAN and the PMN, such as the 3G network, the 4G network, and the like.

As described above, the UE needs the wireless LAN module thereof to be maintained in an active state despite putting up with power consumption thereof, or needs the wireless LAN module thereof to be activated as the need arises.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide an apparatus and a method in which a User Equipment (UE) controls a connection for short-range wireless communication based on a current communication environment of the UE.

Another aspect of the present disclosure is to provide an apparatus and a method in which a UE automatically activates or deactivates a function of connecting to a Wireless Local Area Network (WLAN) according to a current location of the UE.

Still another aspect of the present disclosure is to provide an apparatus and a method in which a UE automatically activates a function of connecting to a WLAN when the UE is located in an area where the UE is registered.

Yet another aspect of the present disclosure is to provide an apparatus and a method in which a UE automatically deactivates a function of connecting to a WLAN when the UE leaves an area where the UE is registered.

Still another aspect of the present disclosure is to provide an apparatus and a method in which a UE determines whether there is a possibility that the UE connects to a WLAN based on information on a neighboring base station.

In accordance with an aspect of the present disclosure, a method for controlling a connection to a local area network (LAN) by a UE capable of selectively connecting to one of the LAN and a public communication network (PCN) is provided. The method includes collecting information on neighboring base stations (BSs) forming the PCN through cell discovery, determining whether a connection is capable of being made to the LAN based on the collected information on the neighboring BSs, and attempting to connect to an access point (AP) previously registered in response to the collected information on the neighboring BSs when it is determined that the connection is capable of being made to the LAN.

In accordance with another aspect of the present disclosure, a UE that is capable of selectively connecting to one of a LAN and a PCN and controls a connection to the LAN is provided. The UE includes a discovery unit configured to collect information on neighboring BSs forming the PCN through cell discovery, a determination unit configured to determine whether a connection is capable of being made to the LAN based on the collected information on the neighboring BSs, and a communication unit configured to attempt to connect to an AP previously registered in response to the collected information on the neighboring BSs when it is determined that the connection is capable of being made to the LAN.

In various embodiments of the present disclosure, the UE automatically connects to a LAN or releases the connection thereto according to a location of the UE. Therefore, the user can not only be provided with convenience, but the cost of communication services can also be reduced without separately operating the UE.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates a wireless communication environment according to an embodiment of the present disclosure;

FIG. 2 illustrates a wireless communication system according to an embodiment of the present disclosure;

FIG. 3 illustrates a configuration of a User Equipment (UE) according to an embodiment of the present disclosure;

FIG. 4 is a flowchart of a main control process performed by a UE according to an embodiment of the present disclosure;

FIG. 5 illustrates a control subroutine performed for establishing an automatic connection to a Local Area Network (LAN), such as the automatic connection subroutine in FIG. 4, according to an embodiment of the present disclosure;

FIG. 6 illustrates a subroutine performed for controlling a connection to a LAN, such as the connection to the LAN in FIG. 4, according to an embodiment of the present disclosure;

FIG. 7 is a flowchart of a subroutine for causing a UE to connect to a previously-registered Access Point (AP), such as the connection to the previously-registered AP in FIG. 6, according to an embodiment of the present disclosure; and

FIG. 8 illustrates a control subroutine for releasing a connection to a LAN, such as the connection release subroutine in FIG. 4, according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, description of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In various embodiments of the present disclosure as described below, an apparatus and a method for controlling a connection to a Local Area Network (LAN) in a User Equipment (UE) capable of selectively connecting to one of the LAN and a Public Communication Network (PCN) will be described.

To this end, the UE manages information on an Access Point (AP) to be connected to the UE in order to connect to the LAN in response to a unique communication environment in a location or an area in which the UE is capable of connecting to the LAN. Accordingly, the UE connects to the LAN based on the information on the AP, which is managed in response to the unique communication environment in a location or an area, which has a communication environment identical to the previously-managed unique communication environment.

Here, with respect to the unique communication environment, it is desired to use a communication environment which is not affected by a change in external conditions, such as temperature, time, the number of users, and the like. This is to minimize the occurrence of a situation in which a change in a communication environment prevents the UE from connecting to a desired LAN even in the identical location or area in which the UE has previously connected to the LAN when use is made of the communication environment that is greatly affected by a change in external conditions.

As an example, as the unique communication environment, use may be made of identification information matched to each of multiple Base Stations (BSs), from which a signal having a strength greater than or equal to a threshold is received. In the present example, it is desirable to previously set the threshold to an extent such that it is possible to compensate for the range of an error caused by a change in the external conditions although the external conditions are changed to some extent. For example, the identification information matched to each BS may use a long code conventionally used in order to identify a BS in a cellular network. However, it is obvious that any information capable of identifying a BS may be applied to various embodiments of the present disclosure.

As another example, a number of BSs may be selected in order of signal strength from stronger to weaker from among BSs of which signals are measured in a location or an area in which the UE connects to the LAN. And the unique communication environment may be defined based on identification information of each of the number of BSs. The selection of the number of BSs in order of signal strength from stronger to weaker is based on the low probability that a signal will not be received in the identical location or area although external conditions are changed when the signal strength is strong.

Examples of a location or area in which the UE is capable of connecting to the LAN may include a house in which a WLAN environment is personally constructed, a company or school in which a WLAN environment is constructed for a common purpose, a specialty coffee shop in which a WLAN environment is constructed for personal business, and the like. The location or area in which the UE is capable of connecting to the LAN needs to be a location or an area in which the UE is not only capable of connecting to the LAN through an AP but is also capable of connecting to the PCN through a BS. It goes without saying that various embodiments of the present disclosure may be applied to a situation where a channel condition is poor and the UE has difficulty in connecting to the PCN through the BS, when the UE receives signals each having a signal strength greater than or equal to a signal strength from multiple BSs.

Hereinafter, various embodiments of the present disclosure will be described with reference to the accompanying drawings.

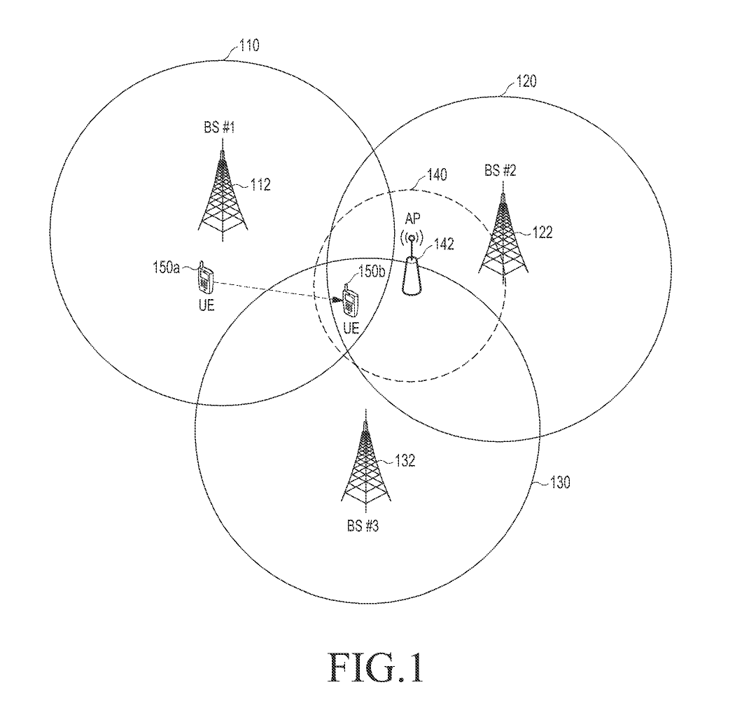

FIG. 1 illustrates a wireless communication environment according to an embodiment of the present disclosure.

Referring to FIG. 1, it is assumed that a PCN (e.g., a Third Generation (3G), Fourth Generation (4G), or the like) includes a BS #1 112, a BS #2 122 and a BS #3 132, and service areas 110, 120 and 130 respectively defined for the BS #1 112, the BS #2 122 and the BS #3 132. Herein, because the BS #1 112, the BS #2 122 and the BS #3 132 are located adjacent to each other, the three services areas 110, 120 and 130 respectively defined for the BS #1 112, the BS #2 122 and the BS #3 132 share an overlapping area therebetween. The overlapping area may be not only an area in which a handoff can be performed, but also an area in which signals transmitted by the BS #1 112, the BS #2 122 and the BS #3 132 can be all received. It is desirable to define the overlapping area as an area in which a signal can be received which has been transmitted by each BS and has more than a threshold signal strength.

A service area (hereinafter referred to as a “short-range communication service area”) 140 of an AP 142, which relays access to the LAN, exists in such a manner as to overlap the three service areas 110, 120 and 130. However, only a part of the short-range communication service area 140 may overlap the three service areas 110, 120 and 130.

In FIG. 1, it is assumed that a UE 150a or 150b, which has used the PCN through the BS #1 112, moves to the location or area 140 in which a UE is capable of using a LAN through the AP 142.

In this case, the UE 150b which has moved into the short-range communication service area 140 attempts to connect to the AP 142. After the UE 150b succeeds in connecting to the AP 142, the UE 150b releases the connection to the PCN through the BS #1 112, and connects to the LAN through the AP 142, to which the UE 150b has succeeded in connecting to.

For example, when the UE 150b first attempts and succeeds in connecting to the AP 142, the UE 150b discovers a cell at the current location. More specifically, the UE 150b collects information on neighboring BSs forming the PCN through the cell discovery. For example, the information on the neighboring BSs, which is collected through the cell discovery, may be information on the strength of a signal received from each of the BS #1 112, the BS #2 122 and the BS #3 132. At this time, as the information on the neighboring BSs, only a signal strength greater than or equal to a threshold may be collected among the signal strengths measured by the cell discovery. Alternatively, the information on the neighboring BSs may be collected with respect to only BSs having signal strengths which are large among the signal strengths measured by the cell discovery.

The UE 150b configures a memory table which manages the information on the neighboring BSs as collected above in response to information on the AP 142 to which the UE 150b has succeeded in connecting to.

Accordingly, the UE 150b manages the information on the neighboring BSs as collected above and the information on the AP to which the UE 150b has succeeded in connecting to, and thereby may automatically connect to the AP 142 by using the managed information when the UE 150b subsequently needs a connection to the AP 142.

For example, the UE 150b collects information on neighboring BSs forming the PCN through the cell discovery. The collecting of the information on the neighboring BSs through the cell discovery in order to use the PCN is not only a typical technology, but is also an operation typically performed for a handoff and the like in the PCN.

The UE 150b may determine whether it enters the short-range communication service area 140 based on whether the collected information on the neighboring BSs coincides with previously-registered information on BSs. For example, the UE 150b may determine whether it is capable of connecting to the LAN through the connection to the AP 142.

When entering the short-range communication service area 140, the UE 150b collects the information on the neighboring BSs similar to the previously-registered information on BSs.

Accordingly, the UE 150b may attempt to connect to the AP 142 by using the previously-registered information on the AP 142 in response to the collected information on the neighboring BSs.

Therefore, as described above, when the UE moves into an area in which short-range communication can be performed without the separate manipulation of the UE by a user, the UE may automatically connect to the LAN.

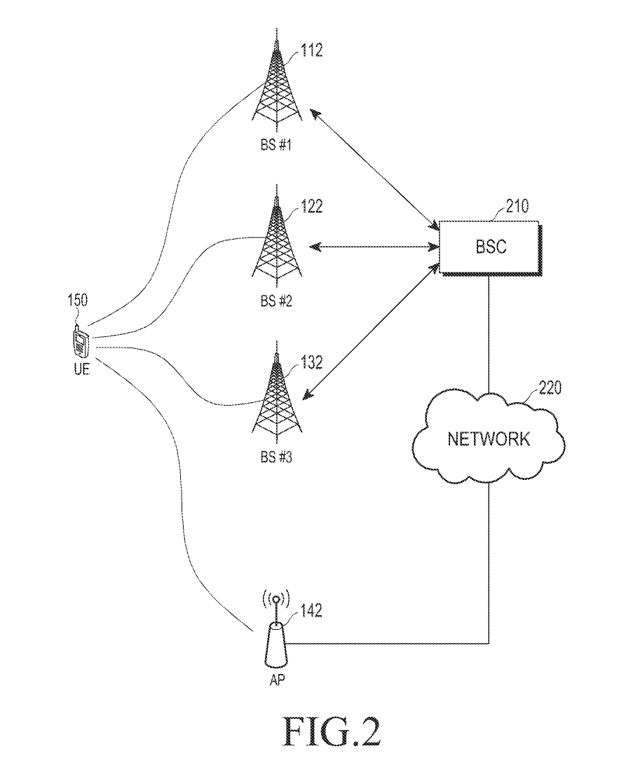

FIG. 2 illustrates a wireless communication system according to an embodiment of the present disclosure.

Referring to FIG. 2, the wireless communication system is based on the wireless communication environment illustrated in FIG. 1 for sake of convenience. Accordingly, FIG. 2 illustrates the BS #1 112, the BS #2 122 and the BS #3 132 which form the PCN, and the one AP 142 forming the LAN. However, it is to be understood that this is only for convenience of description and not to be construed as limiting.

FIG. 2 illustrates a situation in which a UE 150 is capable of connecting to the BS #1 112, the BS #2 122 and the BS #3 132, and the one AP 142. Accordingly, the UE 150 may perform a procedure for an initial connection or a procedure for a reconnection, according to whether the UE 150 has connected to the AP 142. At this time, during the initial connection, the UE 150 performs a procedure for registering information on the AP 142 in response to information on neighboring BSs, according to whether the UE 150 succeeds in connecting to the AP 142. Also, during the reconnection, the UE 150 attempts to connect to the AP 142 by using the registered information on the AP 142 in response to information on neighboring BSs, which has been collected through cell discovery.

Meanwhile, as illustrated in FIG. 2, the BS #1 112, the BS #2 122 and the BS #3 132 access a public network 220, such as the Internet and the like, through a Base Station Controller (BSC) 210, and the AP 142 directly accesses the public network 220, such as the Internet and the like. However, a configuration illustrated in FIG. 2 is only one example, and various embodiments of the present disclosure are not limitedly applied to a path, through which the BS or AP accesses the communication network. In other words, it will be apparent to those skilled in the art that the path through which a connection is made to the communication network is not related to whether various embodiments of the present disclosure are applicable to the path.

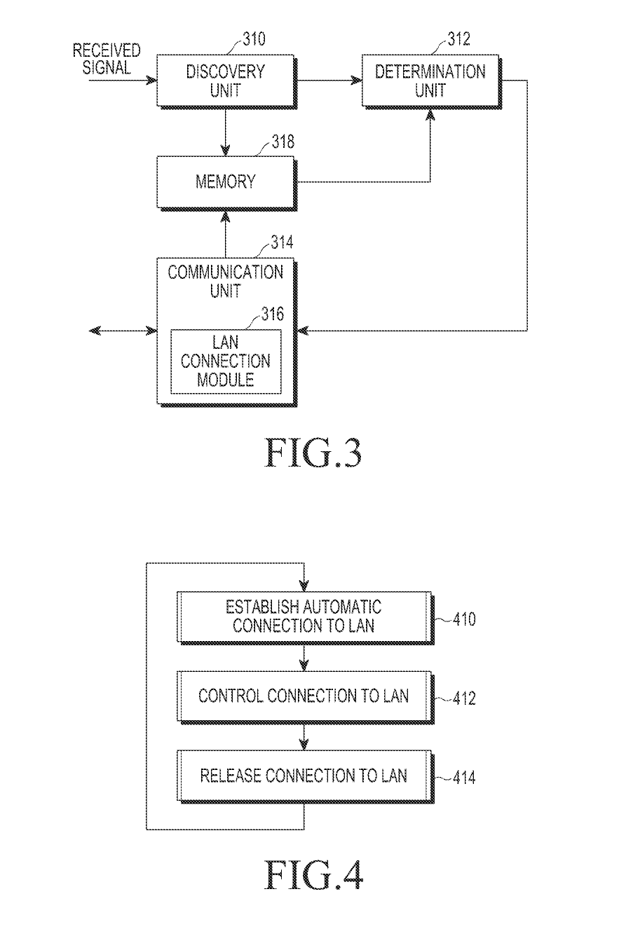

FIG. 3 illustrates a configuration of a UE according to an embodiment of the present disclosure.

Referring to FIG. 3, the UE is capable of selectively connecting to one of a LAN and a PCN and controls the connection to the LAN. Accordingly, the UE includes a discovery unit 310, a determination unit 312, a communication unit 314 including a LAN connection module 316, and a memory 318. Alternatively, the LAN connection module 316 may not be included in the communication unit 314, but may exist as a separate element. Alternatively, the memory 318 may not only be implemented as a separate recording medium, but may also be used by being replaced with a particular allocated area of a recording medium installed in a particular configuration.

The discovery unit 310 performs cell discovery on neighboring BSs forming the PCN, and collects information on the neighboring BSs through the cell discovery. The information on the neighboring BSs does not necessarily include information on all BSs measured by the cell discovery, but may be information on some BSs measured thereby. For example, the discovery unit 310 may select signal strengths which are greater than or equal to a threshold among strengths of received signals, which are measured for all the BSs, and may configure the information on the neighboring BSs by using identification information of neighboring BSs matched to the selected strengths of the received signal.

For example, when the UE succeeds in first connecting to a particular AP, the discovery unit 310 may perform cell discovery. The discovery unit 310 may perform the cell discovery in order to prepare criteria for determining whether there is a possibility that the UE may subsequently connect to the particular AP. More specifically, as described above, the discovery unit 310 prepares the criteria for recognizing a location or an area in which the UE is capable of connecting to the particular AP, based on the information of the neighboring BSs, which is collected through the cell discovery that the discovery unit 310 periodically or aperiodically performs.

In order for the discovery unit 310 to perform the cell discovery when the UE has succeeded in first connecting to the particular AP as described above, the determination unit 312 or the communication unit 314 may report that the UE first connects to the particular AP. In this case, when receiving the report that the UE first connects to the particular AP, the discovery unit 310 does not deliver the collected information on the neighboring BSs to the determination unit 312, but to the memory 318. In contrast, when the determination unit 312 or the communication unit 314 does not report that the UE first connects to the particular AP, the discovery unit 310 delivers the collected information on the neighboring BSs to the determination unit 312.

The memory 318 registers the information on the neighboring BSs provided by the discovery unit 310 in response to information on the particular AP, to which the UE has succeeded in connecting. For example, when the communication unit 314 has succeeded in connecting to the particular AP, the memory 318 registers the information on the particular AP to which the communication unit 314 has succeeded in connecting, in response to the information on the neighboring BSs, which has been collected by the discovery unit 310 at a location at which the UE has succeeded in connecting to the particular AP.

For example, the information on the particular AP to which the UE has succeeded in connecting may include identification information for distinguishing the particular AP. Also, the information on the particular AP to which the UE has succeeded in connecting may include a number which is set for the particular AP at a request from the user. Such a number may be a confidential number (i.e., a secret number) at the discretion of the user.

The determination unit 312 receives the information on the neighboring BSs collected by the discovery unit 310, and determines whether the UE is capable of connecting to the LAN in a current location or area, based on the information on the neighboring BSs provided by the discovery unit 310.

For example, the determination unit 312 compares the information on the neighboring BSs collected by the discovery unit 310 with information on neighboring BSs, which is registered in the memory 318.

When information coinciding with the information on the neighboring BSs collected by the discovery unit 310 exists among the information on the neighboring BSs registered in the memory 318, the determination unit 312 determines that the UE is capable of connecting to an AP registered in response to the information coinciding with the information on the neighboring BSs collected by the discovery unit 310.

However, when information coinciding with the information on the neighboring BSs collected by the discovery unit 310 does not exist among the information on the neighboring BSs registered in the memory 318, the determination unit 312 determines that an AP to which the UE is capable of connecting does not exist in the current location or area. For example, when information coinciding with the information on the neighboring BSs collected by the discovery unit 310 does not exist among the information on the neighboring BSs registered in the memory 318, the determination unit 312 determines that the UE is not capable of connecting to a LAN. Alternatively, when information coinciding with the information on the neighboring BSs collected by the discovery unit 310 does not exist among the information on the neighboring BSs registered in the memory 318, the determination unit 312 determines that an AP to which the UE is capable of connecting has not been previously recognized.

When the determination unit 312 determines that the UE is capable of connecting to the LAN, the communication unit 314 reads information on an AP, which is registered in the memory 318 in response to the information on the neighboring BSs collected by the discovery unit 310. Then, the communication unit 314 recognizes an AP to which the communication unit 314 is to attempt to connect, based on the information on the AP read from the memory 318, and attempts to connect to the recognized AP. More specifically, the communication unit 314 performs an operation of connecting to the recognized AP.

For example, the communication unit 314 includes the LAN connection module 316 therein, and activates the LAN connection module 316 when it is determined that the UE is capable of connecting to the LAN. When the LAN connection module 316 is activated by the communication unit 314, the LAN connection module 316 connects the UE to the AP, to which a connection is determined to be capable of being made in order to connect to the LAN.

When a request is made for releasing the connection to the AP to which the UE is previously connected, or when a situation occurs in which the UE is not capable of maintaining the connection to the LAN, the LAN connection module 316 is changed from an active state to an inactive state. Even in this case, the LAN connection module 316 may be controlled by the communication unit 314.

More specifically, when it is determined that the UE is capable of connecting to the LAN, the communication unit 314 activates the LAN connection module 316. The activated LAN connection module 316 discovers an AP previously registered in response to the information on the neighboring BSs collected by the discovery unit 310. When the discovery unit 310 succeeds in discovering the previously-registered AP within the number of attempts, the LAN connection module 316 connects to the LAN through a connection to the AP that the LAN connection module 316 has succeeded in discovering.

FIG. 4 is a flowchart of a main control process performed by a UE according to an embodiment of the present disclosure.

Referring to FIG. 4, the main control process includes a subroutine 410 for establishing an automatic connection, a subroutine 412 for controlling a connection, and a subroutine 414 for releasing a connection.

In operation 410, the UE establishes an automatic connection to the LAN. Establishing the automatic connection to the LAN is required in order for the UE to automatically connect to the LAN. Representatively, the establishment of the automatic connection to the LAN registers information on neighboring BSs in a location or an area in which the UE is capable of connecting to each AP.

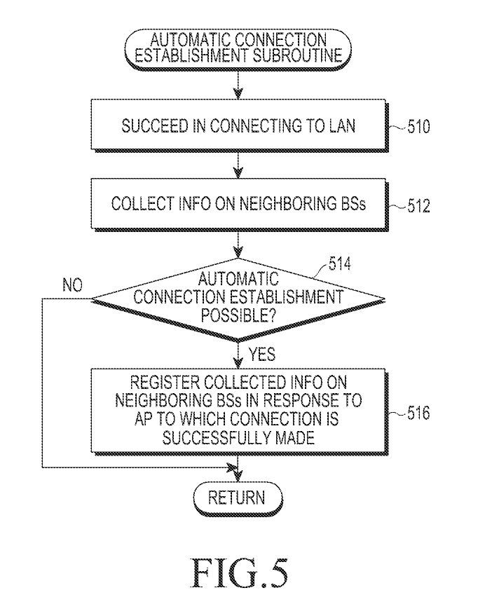

FIG. 5 illustrates a control subroutine performed for establishing an automatic connection to a LAN, such as the automatic connection subroutine in FIG. 4, according to an embodiment of the present disclosure.

Referring to FIG. 5, in operation 510, the UE recognizes that the UE has succeeded in connecting to a particular AP in order to connect to the LAN. When the UE recognizes that the UE has succeeded in connecting to the particular AP, the UE collects information on neighboring BSs in operation 512. For example, the UE performs cell discovery at a location at which the UE has succeeded in connecting to the particular AP, and collects information on neighboring BSs forming the PCN through the cell discovery.

The information on the neighboring BSs collected by the UE may be identification information for distinguishing each of multiple BSs, of which signal strengths greater than or equal to a threshold are measured.

When the UE completes the collection of the information on the neighboring BSs, the UE determines whether the UE is capable of establishing an automatic connection to the LAN in operation 514. For example, based on the collected information on the neighboring BSs, the UE subsequently determines whether the UE is capable of establishing an automatic connection in view of whether the UE is capable of making the automatic connection to the AP, to which the UE has previously connected in order to connect to the LAN. When the strength of a signal received from a neighboring BS is exceedingly weak, or when the number of signals received from neighboring BSs is exceedingly small, it may be desirable to determine that the UE is not capable of establishing the automatic connection to the LAN, based on the collected information on the neighboring BSs.

When determining that the UE is capable of establishing the automatic connection, the UE registers the collected information on the neighboring BSs in response to the AP to which the UE has succeeded in connecting in operation 516. More specifically, the UE maps the collected information on the neighboring BSs to information on the AP to which the UE has succeeded in connecting, and stores the collected information on the neighboring BSs, to which the information on the AP to which the UE has succeeded in connecting is mapped.

Referring again to FIG. 4, when completing the establishment of the automatic connection to the LAN, the UE controls a connection to the LAN in operation 412. To control the connection to the LAN signifies control for allowing the UE to automatically connect to the AP in a location or an area, in which the relevant AP enabling a connection to the LAN exists.

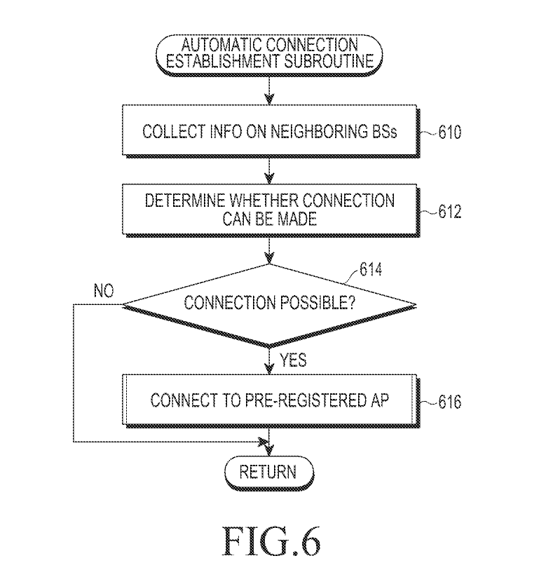

FIG. 6 illustrates a subroutine performed for controlling a connection to a LAN, such as the connection to the LAN in FIG. 4, according to an embodiment of the present disclosure.

Referring to FIG. 6, the UE collects information on neighboring BSs in operation 610. The collection of the information on the neighboring BSs by the UE may be performed by a cell discovery operation typically performed for a handoff in the PCN. More specifically, the UE collects the information on the neighboring BSs forming the PCN through the cell discovery.

In operation 612, the UE determines whether an AP to which the UE is to connect exists, based on the collected information on the neighboring BSs.

To this end, the UE compares the collected information on the neighboring BSs with information on neighboring BSs registered by succeeding in connecting to the AP. Only when information coinciding with the collected information on the neighboring BSs exists among the information on the neighboring BSs registered by succeeding in connecting to the AP, the UE determines that the UE is capable of connecting to the LAN.

In other words, when information coinciding with the collected information on the neighboring BSs does not exist among the information on the neighboring BSs registered by succeeding in connecting to the AP, the UE determines that the UE is not capable of connecting to the LAN.

When a result of the determination in operation 614 shows that the UE is capable of connecting to the LAN, the UE connects to a previously-registered AP. In contrast, when the result of the determination in operation 614 shows that the UE is not capable of connecting to the LAN, the UE completes the subroutine for establishing the automatic connection, and returns to the main routine.

The UE proceeds to operation 616 in order to connect to the previously-registered AP, and attempts to connect to the AP previously registered in response to the collected information on the neighboring BSs. For example, the previously-registered AP, to which the UE is to attempt to connect, is identified by using information on a particular AP, which has previously been registered in response to the information coinciding with the collected information on the neighboring BSs and to which the UE has succeeded in connecting.

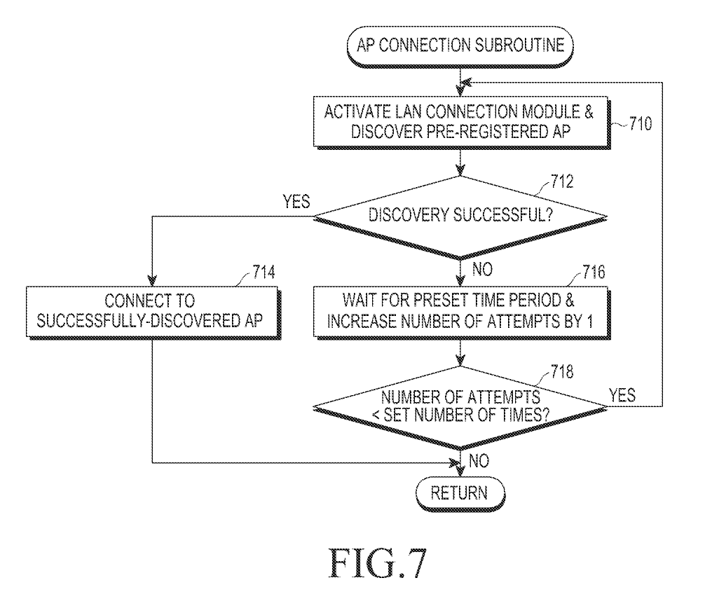

FIG. 7 is a flowchart of a subroutine for causing a UE to connect to a previously-registered AP, such as the connection to the previously-registered AP of FIG. 6, according to an embodiment of the present disclosure.

Referring to FIG. 7, the UE activates the LAN connection module, and discovers an AP, to which the UE is to attempt to connect, through the activated LAN connection module in operation 710. More specifically, the UE identifies whether the AP to which the UE is to attempt to connect is in a connectable state. For example, depending on the reception of a probe message transmitted by the AP to which the UE is to attempt to connect, the UE may discover the relevant AP.

When determining in operation 712 that the UE has succeeded in discovering the AP to which the UE is to attempt to connect, the UE proceeds to operation 714. In operation 714, the UE performs a procedure for connecting to the AP that the UE has succeeded in discovering. When the UE successfully connects to the AP that the UE has succeeded in discovering, the UE is capable of connecting to the LAN.

However, when determining in operation 712 that the UE has failed to discover the AP to which the UE is to attempt to connect, the UE proceeds to operation 716, and waits for a time period. Also, the UE increases a count value, which counts the number of attempted connections, by 1. After waiting for the time period, the UE proceeds to operation 718, and determines whether the UE has attempted to connect to the AP by a threshold number of times. More specifically, the UE determines whether the number of attempted connections which has previously increased by 1 is less than or equal to the threshold number of times.

FIG. 7 illustrates a case in which the UE waits for the time period before the UE completes the attempt for connection when the UE attempts to connect to the AP by the threshold number of times. However, it goes without saying that the UE may complete the subroutine for connecting to the AP without waiting for the time period when the UE attempts to connect to the AP by the number of times.

When determining that the UE has not attempted to connect to the AP by the threshold number of times, the UE returns to operation 710, and again attempts to connect to the relevant AP in operations 710 to 718.

Referring again to FIG. 4, when the UE makes an automatic connection to the desired AP by controlling the connection to the LAN, in operation 414, the UE releases the connection to the LAN. To release the connection to the LAN corresponds to a subroutine, in which the UE first senses a change in a situation when the situation where the UE is capable of connecting to the LAN is changed and then the UE automatically releases the connection to the relevant AP.

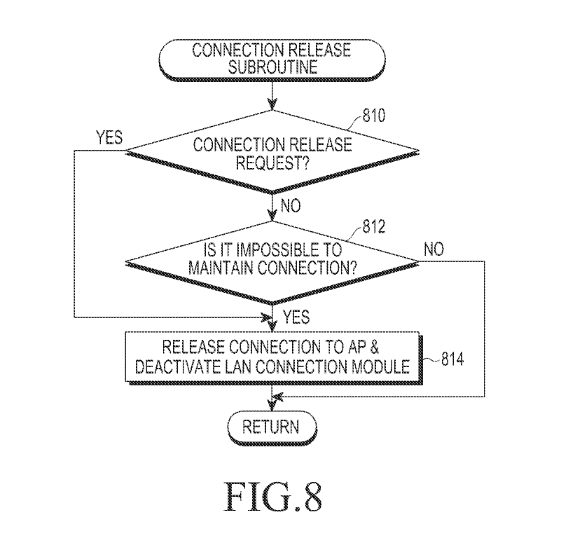

FIG. 8 illustrates a control subroutine for releasing a connection to a LAN, such as the connection release subroutine of FIG. 4, according to an embodiment of the present disclosure.

Referring to FIG. 8, the UE determines in operation 810 whether the UE receives a request for releasing the connection to the AP which is currently in a connection state, or determines in operation 812 whether a situation occurs in which the UE is not capable of maintaining the connection to the AP. For example, the request for releasing the connection to the AP which is currently in a connection state may be made by the user or the AP. Also, the situation in which the UE is not capable of maintaining the connection to the AP may be a situation in which the UE is not capable of maintaining the state, in which the UE connects to the AP, due to the movement of the UE.

When the UE receives the request for releasing the connection to the AP, or when the situation occurs in which the UE is not capable of maintaining the connection to the AP, the UE releases the connection to the AP which is currently in the connection state in operation 814. Then, after releasing the connection to the AP, the UE deactivates the LAN connection module, and thereby prevents the occurrence of unnecessary power consumption in order to connect to the LAN.

FIG. 8 illustrates the release of the connection to the AP and the deactivation of the LAN connection module in operation 814 as separate operations. However, the two operations may be defined as one operation of deactivating the LAN connection module. It is possible to define the two operations as one operation because the connection to the AP can be released by deactivating the LAN connection module.

While the present disclosure has been shown and described with reference to various embodiments thereof, it will be understood by those skilled in the art that various changes in form and details may be made therein without departing from the spirit and scope of the present disclosure as defined by the appended claims and their equivalents.

1. A method for controlling a connection to a local area network (LAN) in a user equipment (UE) capable of selectively connecting to one of the LAN and a public communication network (PCN), the method comprising:
collecting information on neighboring base stations (BSs) forming the PCN through cell discovery;
determining whether a connection is capable of being made to the LAN based on the collected information on the neighboring BSs; and
attempting to connect to an access point (AP) previously registered in response to the collected information on the neighboring BSs when it is determined that the connection is capable of being made to the LAN.

2. The method as claimed in claim 1, further comprising:
collecting the information on the neighboring BSs forming the PCN through cell discovery at a location at which a connection is successfully made to a particular AP when the connection is successfully made to the particular AP in order to connect to the LAN; and
registering information on the particular AP to which the connection is successfully made in response to the collected information on the neighboring BSs.

3. The method as claimed in claim 1, wherein the information on the neighboring BSs corresponds to identification information for distinguishing each of multiple BSs, of which signal strengths greater than or equal to a threshold are measured, through the cell discovery.

4. The method as claimed in claim 2, wherein the determining of whether the connection is capable of being made to the LAN comprises:
comparing the information on the neighboring BSs, which has been collected in order to determine whether the connection is capable of being made to the LAN, with information on neighboring BSs, which are registered after the connection is successfully made to the particular AP;
determining that the connection is capable of being made to the LAN when information coinciding with the information on the neighboring BSs collected in order to determine whether the connection is capable of being made to the LAN exists among the information on the neighboring BSs registered after the connection is successfully made to the particular AP; and
determining that the connection is not capable of being made to the LAN when the information coinciding with the information on the neighboring BSs collected in order to determine whether the connection is capable of being made to the LAN does not exist among the information on the neighboring BSs registered after the connection is successfully made to the particular AP.

5. The method as claimed in claim 4, wherein the previously-registered AP to which a connection is to be attempted is identified by using the information on the particular AP to which the connection is successfully made, which is registered in response to the information coinciding with the information on the neighboring BSs collected in order to determine whether the connection is capable of being made to the LAN.

6. The method as claimed in claim 1, wherein the attempting to connect to the AP comprises:
activating a LAN connection module and discovering the AP previously registered in response to the collected information on the neighboring BSs through the activated LAN connection module, when it is determined that the connection is capable of being made to the LAN; and
connecting to the LAN by connecting to the successfully-discovered AP, when the previously-registered AP is successfully discovered within a threshold number of attempts.

7. The method as claimed in claim 2, wherein the information on the particular AP to which the connection is successfully made includes identification information for distinguishing the particular AP, and includes a number which is set for the particular AP at a request from a user of the UE.

8. A user equipment (UE) that is capable of selectively connecting to one of a local area network (LAN) and a public communication network (PCN) and controls a connection to the LAN, the UE comprising:
a discovery unit configured to collects information on neighboring base stations (BSs) forming the PCN through cell discovery;
a determination unit configured to determines whether a connection is capable of being made to the LAN based on the collected information on the neighboring BSs; and
a communication unit configured to attempts to connect to an access point (AP) previously registered in response to the collected information on the neighboring BSs when it is determined that the connection is capable of being made to the LAN.

9. The UE as claimed in claim 8, further comprising a memory configured to registers information on a particular AP, to which a connection is successfully made, in response to information on neighboring BSs forming the PCN, which is collected through the cell discovery of the discovery unit at a location at which the connection is successfully made to the particular AP, when the connection is successfully made to the particular AP in order to connect to the LAN.

10. The UE as claimed in claim 8, wherein the information on the neighboring BSs corresponds to identification information for distinguishing each of multiple BSs, of which signal strengths greater than or equal to a threshold are measured, through the cell discovery.

11. The UE as claimed in claim 9, wherein the determination unit if further configured to:
compare the information on the neighboring BSs, which has been collected in order to determine whether the connection is capable of being made to the LAN, with information on neighboring BSs, which is registered after the connection is successfully made to the particular AP;
determine that the connection is capable of being made to the LAN when information coinciding with the information on the neighboring BSs collected in order to determine whether the connection is capable of being made to the LAN exists among the information on the neighboring BSs registered after the connection is successfully made to the particular AP; and
determine that the connection is not capable of being made to the LAN when the information coinciding with the information on the neighboring BSs collected in order to determine whether the connection is capable of being made to the LAN does not exist among the information on the neighboring BSs registered after the connection is successfully made to the particular AP.

12. The UE as claimed in claim 11, wherein the communication unit is further configured to identify the previously-registered AP, to which a connection is to be attempted, by using the information on the particular AP to which the connection is successfully made, which is registered in response to the information coinciding with the information on the neighboring BSs collected in order to determine whether the connection is capable of being made to the LAN.

13. The UE as claimed in claim 8, wherein the communication unit is further configured to:
activate a LAN connection module and discover the AP previously registered in response to the collected information on the neighboring BSs through the activated LAN connection module, when it is determined that the connection is capable of being made to the LAN; and
connect to the LAN by connecting to the successfully-discovered AP, when the previously-registered AP is successfully discovered within a threshold number of attempts.

14. The UE as claimed in claim 9, wherein the information on the particular AP to which the connection is successfully made includes identification information for distinguishing the particular AP, and includes a number which is set for the particular AP at a request from a user of the UE.

15. The method as claimed in claim 1, further comprising:
determining whether an AP connection release request is received; and
releasing the connection to the AP if the connection release request is received.

16. The method as claimed in claim 1, further comprising:
determining whether it is possible to maintain the AP connection; and
releasing the connection to the AP if the connection is not possible.

17. The method as claimed in claim 16, wherein the determining of whether it is possible to maintain the AP connection comprises determining a movement of the UE.

18. The UE as claimed in claim 8, wherein the determination unit if further configured to:
determine whether an AP connection release request is received; and
release the connection to the AP if the connection release request is received.

19. The UE as claimed in claim 8, wherein the determination unit is further configured to:
determine whether it is possible to maintain the AP connection; and
release the connection to the AP if the connection is not possible.

20. The UE as claimed in claim 19, wherein the determination unit determines whether it is possible to maintain the AP connection by determining a movement of the UE.
